(19) United States
(12) Patent Application Publication
(10) Pub. No.: US 2006/0186355 A1
(43) Pub. Date: Aug. 24, 2006

(54) Phase-shift masked zone plate array lithography

(76) Inventors: Henry I. Smith, Sudbury, MA (US); George Barbastathis, Boston, MA (US); Rajesh Menon, Cambridge, MA (US)

Correspondence Address: Gauthier & Connors LLP, Suite 2300, 225 Franklin Street, Boston, MA, 02110, US

(21) Appl. No.: 11/347,138

(22) Filed: Feb. 3, 2006

Related U.S. Application Data
(60) Provisional application No. 60/650,332, filed on Feb. 4, 2005.

(51) Int. Cl. G21K 5/10

(52) U.S. Cl. 250/492.22

(57) ABSTRACT

A lithography system includes a source of radiation energy and a zone plate array to focus the radiation energy to create an array of images in order to produce a permanent pattern on a substrate. A phase-shift mask is optically located between the source of radiation energy and the zone plate array. The modulated wavefront produced by the phase-shift mask alters the field diffracted by the zone plate array, and the center lobe of the point-spread function narrows as a result.

### PRIORITY INFORMATION

The present patent application claims priority under 35 U.S.C. §119 from U.S. Provisional Patent Application Ser. No. 60/650,332, filed on Feb. 4, 2005. The entire content of U.S. Provisional Patent Application Ser. No. b 60/650,332, filed on Feb. 4, 2005 is hereby incorporated by reference.

### FIELD OF THE PRESENT INVENTION

The present invention is directed to lithography using an array of Fresnel zone plates. More particularly, the present invention to lithography using a combination of a phase-shift mask and an array of Fresnel zone plates.

### BACKGROUND OF THE PRESENT INVENTION

Lithography is conventionally performed by a variety of systems and methods. Optical projection lithography employs a reticle (also called a mask) which is then imaged onto a substrate using either refractive or reflective optics, or a combination of the two. The reticle or mask contains the pattern to be created on the substrate, or a representation thereof. Often, but not always, the optics produces a reduction of the reticle image by a factor between 4 and 10. In other cases there is no reduction of magnification, often referred to as 1-to-1 imaging.

X-ray lithography employs a mask held in close proximity (e.g., a gap of zero to 50 micrometers) to the substrate. By passing x-ray radiation through the mask, the pattern on the mask is replicated in a radiation-sensitive film on the substrate. This film is commonly called a “resist.”

Electron-beam lithography is often carried out by scanning a well focused electron beam over a substrate coated with a resist. By turning the beam ON and OFF at appropriate times, in response to commands from a control computer, any general 2-dimensional pattern can be created. This form of electron-beam lithography is referred to as a “maskless lithography,” since no mask is employed.

Another form of lithography is the zone plate array lithography as disclosed in U.S. Pat. No. 5,900,637. The entire content of U.S. Pat. No. 5,900,637 is hereby incorporated by reference.

In zone plate array lithography, an array of Fresnel zone plates is placed one focal distance away from the substrate. Each Fresnel zone plate can be individually addressed by a spatial light modulator to create an arbitrary dot-illumination matrix.

An example of an array of Fresnel zone plates is illustrated in FIG. 1. As illustrated in FIG. 1, a maskless lithography arrangement 10 in accordance with the invention which includes an array 100 of Fresnel zone plates 102 configured on a (110) silicon substrate (not shown). Each zone plate 102, which defines a “unit cell,” is supported on a thin carbonaceous membrane 106, with vertical, anisotropically-etched Si (111) joists 108 for rigid mechanical support. Each zone plate 102 is responsible for exposure only within its unit cell.

The joists 108, which in the illustrated exemplary embodiment are made of (111) Si, are intended to provide additional rigidity to the array while minimizing obstruction. The membrane 106 is made of thin carbonaceous material because it is transparent to a beam source of 4.5 nm x-ray. If deep UV radiation is used, the membrane can be made of glass, and the zone plates could be made from phase zone plates; i.e., grooves cut into the glass membrane.

FIG. 2 illustrates a cross-sectional schematic view of an exemplary embodiment of a zone plate array lithography system 20 wherein the incident beamlets 212 are focused from an x-ray beam source 210 onto a substrate 204 coated with a resist 214 as focused beamlets 213. The arrangement includes micro-mechanical shutter devices 218 with actuated shutters 219, which turn the focused beamlets ON and OFF in response to commands from a control computer 230. The shutter devices 218 are interposed between the zone plate array 200, joists 208, stops 220, and the substrate 204.

As illustrated in FIG. 2, each of the zone plates 202 of the array 200 is able to focus a collimated beamlet 212 of x-rays to a fine focal spot 215 on the resist-coated substrate 204 which is supported on a positioning stage 216. To write a pattern, the substrate is scanned under the array, while the individual beamlets 213 are turned ON and OFF as needed by micromechanical shutters 218, one associated with each zone plate. These shutters can be located either between the zone plate array and the substrate or between the zone plate array and the source of radiation.

FIG. 3 is an illustration of one possible writing scheme used in connection with an exemplary embodiment of zone plate array lithography system 30. The arrangement includes an array of upstream mirrors 305 positioned between the array 300 of Fresnel zone plates 302 and the radiation source 310. A serpentine writing scheme 320 is depicted, with the substrate scanned in X and Y by a fast piezoelectric system (not shown), thereby filling in the full pattern.

Radiation of 4.5 nm wavelength is readily reflected at glancing angles from a polished surface. Accordingly, an array of micromechanical, deflectable glancing-angle mirrors 305, located upstream, can be used to turn individual focused beamlets 313 ON and OFF.

Although conventional zone plate array lithography systems have many advantages, it is difficult to control the size and phase profile of the point-spread function in conventional zone plate array lithography systems.

Thus, it is desirable to provide a zone plate array lithography system that provides control of the size and phase profile of the point-spread function.

### SUMMARY OF THE PRESENT INVENTION

One aspect of the present invention is a lithography system including a source of radiation energy; a zone plate array to focus the radiation energy to create an array of images in order to produce a permanent pattern on a substrate; and a phase-shift mask optically located between the source of radiation energy and the zone plate array.

Another aspect of the present invention is a lithography system including a source of radiation energy and a zone plate array to focus the radiation energy to create an array of images in order to produce a permanent pattern on a substrate. The zone plate array includes a plurality of diffractive-optical elements, each diffractive-optical element having a phase-shifting element incorporated therein.

Another aspect of the present invention is a lithography system including a source of radiation energy; a zone plate array to focus the radiation energy to create an array of images in order to produce a permanent pattern on a substrate; and a beam modulator being positioned between the source of radiation energy and the zone plate array, the beam modulator including phase-shifting element incorporated therein.

Another aspect of the present invention is a substrate imaged using a lithography system having a source of radiation energy; a zone plate array to focus the radiation energy to create an array of images in order to produce a permanent pattern on a substrate; and a phase-shift mask optically located between the source of radiation energy and the zone plate array.

A further aspect of the present invention is a method of imaging a substrate using lithography by providing a source of radiation energy; modulating a wavefront of the radiation energy using a phase-shift mask; and focusing, using a zone plate array, the radiation energy from the phase-shift mask to create an array of images in order to produce a permanent pattern on a substrate.

A further aspect of the present invention is a method of imaging a substrate using lithography by providing a source of radiation energy; phase-shifting a portion of a wavefront of the radiation energy using a phase-shift mask; and focusing, using a zone plate array, the radiation energy from the phase-shift mask to create an array of images in order to produce a permanent pattern on a substrate.

A further aspect of the present invention is a method of imaging a substrate using lithography by providing a source of radiation energy; phase-shifting a wavefront of the radiation energy using a phase-shift mask; and focusing, using a zone plate array, the radiation energy from the phase-shift mask to create an array of images in order to produce a permanent pattern on a substrate.

### BRIEF DESCRIPTION OF THE DRAWINGS

The present invention may take form in various components and arrangements of components, and in various steps and arrangements of steps. The drawings are only for purposes of illustrating a preferred embodiment or embodiments and are not to be construed as limiting the present invention, wherein:

FIG. 1 is a perspective view of an array of Fresnel zone plates configured on a silicon substrate in accordance with the invention;

FIG. 2 is a cross-sectional schematic view of an exemplary embodiment illustrating the focusing of incident beamlets onto a resist-coated substrate;

FIG. 3 is a schematic illustration of an exemplary writing scheme; and

FIG. 4 is block diagram of a zone plate array lithography system with a phase-shift mask according to the concepts of the present invention;

FIG. 5 is a graphical illustration the convolution of the image of the phase-shift mask with the zone plate's point-spread function;

FIG. 6 shows the geometry, where the phase-shift mask's exterior radius is R, and p₁ and p₂ denote the fractions of phase-shift mask aperture occupied by the ring-shaped phase-shift mask;

FIG. 7 illustrates a comparison between point-spread functions of a conventional zone plate array lithography system and a zone plate array lithography system with a phase-shift mask according to the concepts of the present invention;

FIG. 8 graphically illustrates a calculation of the full-width-at-half maximum of the point-spread function of a zone plate array lithography system with a phase-shift mask according to the concepts of the present invention; and

FIGS. 9-11 are block diagrams illustrating different implementations of a zone plate array lithography system with a phase-shift mask according to the concepts of the present invention.

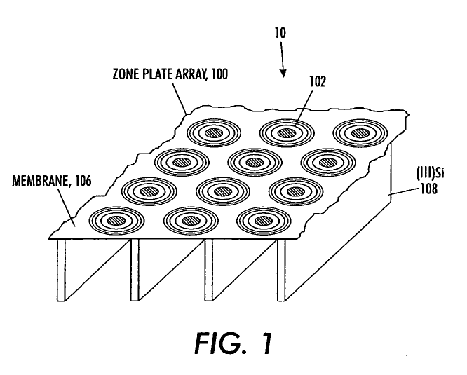

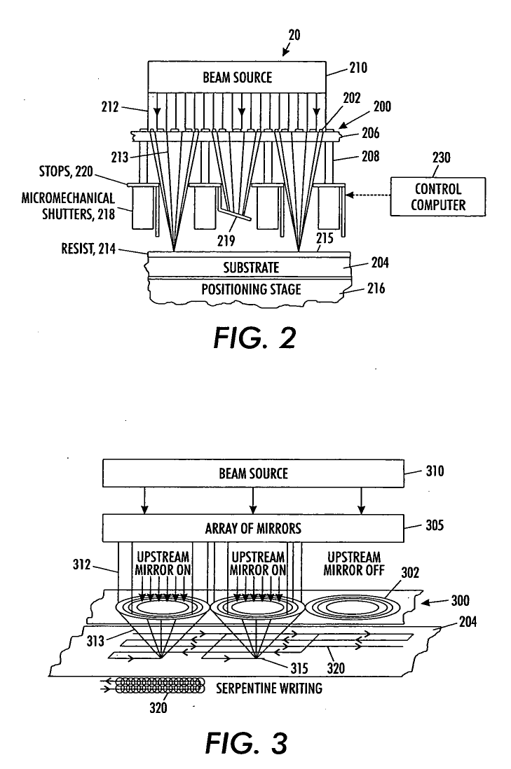

### DETAILED DESCRIPTION OF THE PRESENT INVENTION

The present invention will be described in connection with preferred embodiments; however, it will be understood that there is no intent to limit the present invention to the embodiments described herein. On the contrary, the intent is to cover all alternatives, modifications, and equivalents as may be included within the spirit and scope of the present invention as defined by the appended claims.

For a general understanding of the present invention, reference is made to the drawings. In the drawings, like reference numbering has been used throughout to designate identical or equivalent elements. It is also noted that the various drawings illustrating the present invention may not have been drawn to scale and that certain regions may have been purposely drawn disproportionately so that the features and concepts of the present invention could be properly illustrated.

As noted above, it is desirable to provide a zone plate array lithography system that provides control of the size and phase profile of the point-spread function. To realize such a system, the present invention utilizes a phase-shift mask in conjunction with the zone plate array lithography system. In the system of the present invention, the phase-shift mask used to control the size and phase profile of the point-spread function so as to optimize the lateral shape of the point-spread function in terms of narrowness or depressed side-lobes.

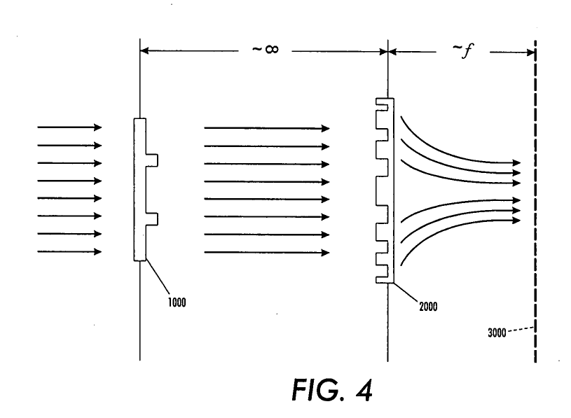

FIG. 4 illustrates a model of a zone plate array lithography system, which includes a phase-shift mask, to optimize the lateral shape of the point-spread function in terms of narrowness or depressed side-lobes. As illustrated in FIG. 4, a phase-shift mask 1000 is placed in the path of the optical beams leading to a zone plate array 2000, such that the phase-shift mask 1000 is imaged onto the zone plate array 2000 to modulate the wavefront. The phase-shift mask may introduce a phase shift on selected parts of the wavefront emitted by the source of radiation energy. The modulated wavefront produced by the phase-shift mask 1000 alters the field diffracted by the zone plate array 2000, and the center lobe of the optical point-spread function narrows as a result.

As illustrated FIG. 4, the geometrical configuration for the zone plate array lithography system, which includes a phase-shift mask, shows one pair of a phase-shift mask 1000 and a zone plate array 2000. However, it is noted that in the zone plate array lithography system includes an array of phase-shift mask and zone plate array pairs.

In one embodiment of the present invention, the phase-shift mask is shaped as a ring with a phase shift of π. Moreover, another example of a usable phase-shift mask is disclosed in U.S. Pat. No. 4,890,309. The entire content of U.S. Pat. No. 4,890,309 is hereby incorporated by reference.

It is further noted that, as shown in FIG. 4, the phase-shift mask 1000 is placed very far from the zone plate array 2000 such that the Fraunhofer (far field) diffraction pattern of the phase-shift ring is formed on the zone plate array 2000. In other words, the phase-shift mask 1000 has been illustrated as being located at infinity.

It is noted that any object located at a distance exceeding the limit A²/λ, where A, is the aperture of the phase-shift mask and λ the shortest wavelength emitted by the source of radiation, is considered to be in the Fraunhofer diffraction regime, i.e. at infinity.

The zone plate array 2000 forms an image of the phase-shift mask 1000 at the zone plate's focal plane 3000; i.e. one focal distance ƒ behind the zone plate array 2000. It is noted that ƒ denotes the focal length of the first diffracted order of the zone plate array 2000.

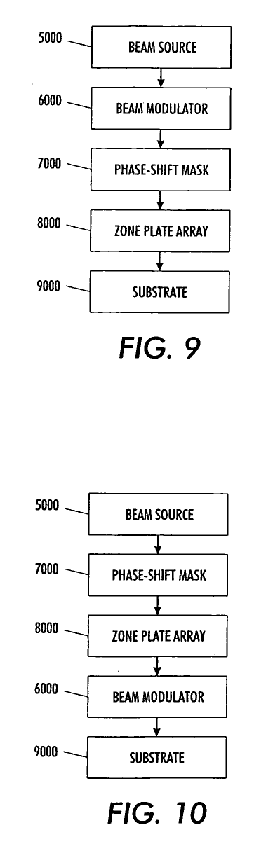

FIGS. 9-11 illustrates various implementations of a zone plate array lithography system, which includes a phase-shift mask.

As illustrated in FIG. 9, the zone plate array lithography system, which includes a phase-shift mask, includes a beam source 5000 to generate a source of radiation; such as an x-ray beam, ultraviolet radiation, deep ultraviolet radiation, optical radiation at other wavelength regimes, etc. The radiation is modulated by beam modulator 6000 to create a plurality of individual beamlets of radiation. The beam modulator 6000 turns ON and OFF each beamlet depending upon the pattern to be imaged on the substrate.

The beamlets pass through the phase-shift mask 7000 so as to modulate the wavefront of each beamlet. The phase-shift mask 7000 may introduce a phase shift on selected parts of the wavefront emitted by the source of radiation energy. Thereafter, the beamlets pass through the zone plate array 8000 before being imaged upon the substrate 9000.

As illustrated in FIG. 10, the zone plate array lithography system, which includes a phase-shift mask, includes a beam source 5000 to generate a source of radiation; such as an x-ray beam, ultraviolet radiation, deep ultraviolet radiation, optical radiation at other wavelength regimes, etc. The beam passes through the phase-shift mask 7000 so as to modulate the wavefront of the beam. The phase-shift mask 7000 may introduce a phase shift on selected parts of the wavefront emitted by the source of radiation energy. Thereafter, the beam passes through the zone plate array 8000.

The radiation from the zone plate array 8000 is modulated by beam modulator 6000 to create a plurality of individual beamlets of radiation. The beam modulator 6000 turns ON and OFF each beamlet depending upon the pattern to be imaged on the substrate 9000.

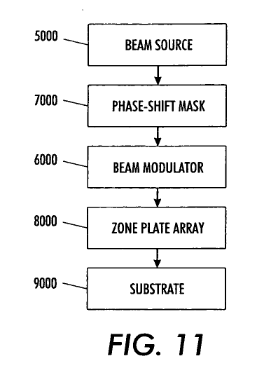

As illustrated in FIG. 11, the zone plate array lithography system, which includes a phase-shift mask, includes a beam source 5000 to generate a source of radiation; such as an x-ray beam, ultraviolet radiation, deep ultraviolet radiation, optical radiation at other wavelength regimes, etc. The beam passes through the phase-shift mask 7000 so as to modulate the wavefront of the beam. The phase-shift mask 7000 may introduce a phase shift on selected parts of the wavefront emitted by the source of radiation energy.

Thereafter, the beam passes through beam modulator 6000 to create a plurality of individual beamlets of radiation. The beam modulator 6000 turns ON and OFF each beamlet depending upon the pattern to be imaged on the substrate 9000. The various beamlets from the beam modulator 6000 pass through the zone plate array 8000 before being imaged upon the substrate 9000.

In the various implementations illustrated in FIGS. 4 and 9-11, the image of the phase-shift mask is convolved with the zone plate's point-spread function, resulting in a composite point-spread function that has a narrow main lobe, provided the exterior and interior ring radii are chosen appropriately.

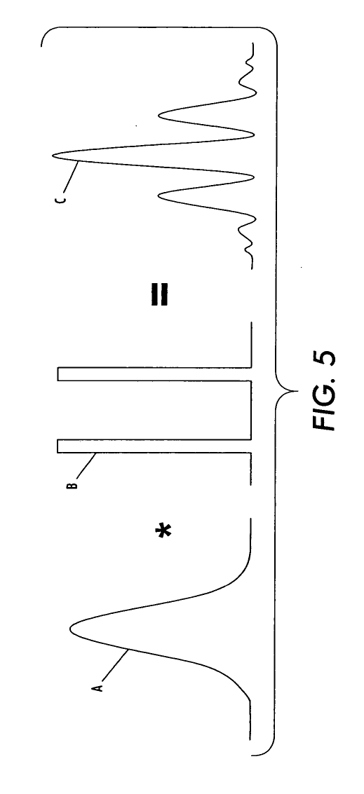

The convolution process is illustrated in FIG. 5. As illustrated in FIG. 5, the phase-shift mask's image A, in this embodiment the phase-shift mask is a phase-shift ring mask, is convolved with the zone plate's point-spread function B to create a point-spread function C having a narrower center lobe. It is noted that the side lobes of the point-spread function C of the zone plate array lithography system, which includes a phase-shift mask of the present invention, are higher than a conventional zone plate lithography system (without a phase-shift mask). The increase in power of side-lobes in a lithography system with properly chosen photoresists and process latitude is usually inconsequential compared to the benefit of narrowing the main lobe.

More specifically, FIG. 7 illustrates a comparison between the point-spread function D of a conventional zone plate lithography system (without a phase-shift mask) and the point-spread function C of the zone plate array lithography system, which includes a phase-shift mask of the present invention.

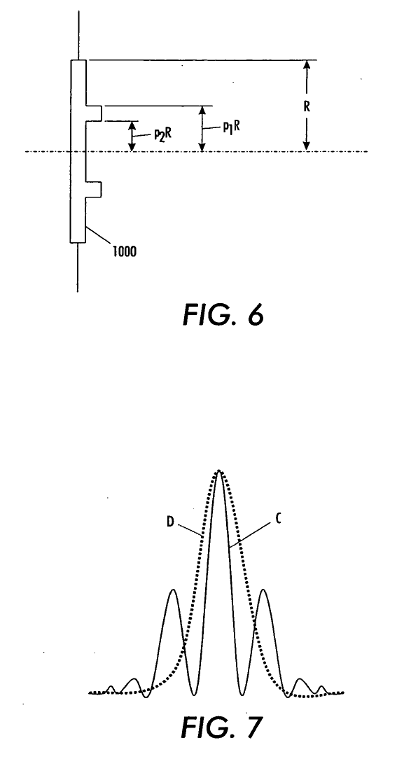

FIG. 6 shows the geometry, where the phase-shift mask's exterior radius is R, and p₁ and p₂ denote the fractions of phase-shift mask aperture occupied by the ring-shaped phase-shift mask.

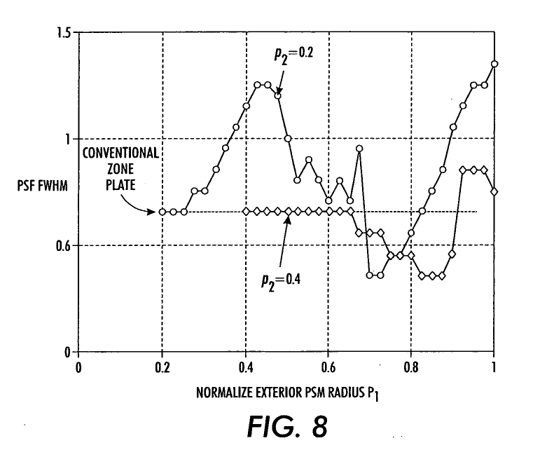

FIG. 8 illustrates the numerical calculation of the full-width-at-half maximum of the point-spread function of the zone plate array lithography system, which includes a phase-shift mask of the present invention for various values of the interior radius of the phase-shift mask.

It is noted that phase-shift mask may contain one or more phase-shifting rings (or an array thereof) in combination with a diffractive-optical element. It is further noted that the zone plate array lithography system could include an array of diffractive-optical elements instead of a mask with an array of phase-shifting rings.

It is also noted that the phase-shifting elements of the phase-shift mask may be a ring, or a combination of concentric rings, so as to achieve the desired pattern on the substrate.

It is further noted that the zone plate array may be Fresnel zone plates, Frensel phase zone plates, amplitude zone plates, blazed zone plates, refractive microlenses, refractive lenses, modified zone plates, Bessel zone plates, photon sieves (for example, amplitude photon sieves, phase photon sieves, or alternating phase photon sieves), apodized lenses, and other geometries, which are designed to achieve the final diffraction pattern on the substrate.

It is noted that the phase-shift mask may also be incorporated into an upstream spatial-light multiplexor, which switches the beamlets ON and OFF for each diffractive-optical element in the zone plate array.

It is further noted that phase-shifting elements can also be incorporated into the design of the diffractive-optical elements in the zone plate array, by calculating the appropriate field incident on the diffractive-optical array, binarizing this field, and imposing it on the geometry of the diffractive-optical element.

The above-described the zone plate array lithography system, which includes a phase-shift mask, can be used also for fabrication of micro and nanoelectronics, integrated optics, micro and nano-magnetics, micro-electro-mechanical systems, thin-film transistors, integrated circuits, microfluiudics, superconducting electronics, and biochips.

The above-described zone plate array lithography system, which includes a phase-shift mask, can be used for purposes other than lithography, for example microscopy including scanning confocal microscopy, scanning optical microscopy, scanning transmission microscopy, fluorescent confocal microscopy, fluorescent microscopy, two-photon microscopy, stimulated depletion microscopy, other forms of non-linear microscopy.

While the present invention has been particularly shown and described with references to preferred embodiments thereof, it will be understood by those skilled in the art that various changes in form and detail may be made herein without departing from the spirit and scope of the invention as defined by the appended claims.

What is claimed is:

1. A lithography system comprising:
a source of radiation energy;
a zone plate array to focus said radiation energy to create an array of images in order to produce a permanent pattern on a substrate; and
a phase-shift mask optically located between said source of radiation energy and said zone plate array.

2. The lithography system as claimed in claim 1, further comprising:
a beam modulator being positioned between said source of radiation energy and said phase-shift mask.

3. The lithography system as claimed in claim 1, further comprising:
a beam modulator being positioned between said zone plate array and the substrate.

4. The lithography system as claimed in claim 1, further comprising:
a beam modulator being positioned between said phase-shift mask and said zone plate array.

5. The lithography system as claimed in claim 1, wherein said phase-shift mask is a phase-shift ring mask.

6. The lithography system as claimed in claim 5, wherein said phase-shift ring mask imposes a phase shift of π radians on the portion of a wavefront that is incident on said ring.

7. The lithography system as claimed in claim 1, wherein said phase-shift mask introduces a phase shift on selected parts of a wavefront emitted by said source of radiation energy.

8. The lithography system as claimed in claim 1, wherein said phase-shift mask includes a plurality of phase-shifting elements.

9. The lithography system as claimed in claim 8, wherein each phase-shifting element is a phase-shift ring.

10. The lithography system as claimed in claim 9, wherein said phase-shift rings impose a phase shift of π radians on the portion of a wavefront that is incident on each said ring.

11. The lithography system as claimed in claim 9, wherein each phase-shifting element is a plurality of concentric rings.

12. A lithography system comprising:
a source of radiation energy; and
a zone plate array to focus said radiation energy to create an array of images in order to produce a permanent pattern on a substrate;
said zone plate array including a plurality of diffractive-optical elements, each diffractive-optical element having a phase-shifting element incorporated therein.

13. The lithography system as claimed in claim 12, wherein each phase-shifting element is a phase-shift ring.

14. The lithography system as claimed in claim 13, wherein said phase-shift rings impose a phase shift of π radians on the portion of a wavefront that is incident on each said ring.

15. The lithography system as claimed in claim 12, wherein each phase-shifting element is a plurality of concentric rings.

16. A lithography system comprising:
a source of radiation energy;
a zone plate array to focus said radiation energy to create an array of images in order to produce a permanent pattern on a substrate; and
a beam modulator being positioned between said source of radiation energy and said zone plate array, said beam modulator including phase-shifting element incorporated therein.

17. The lithography system as claimed in claim 16, wherein each phase-shifting element is a phase-shift ring.

18. The lithography system as claimed in claim 17, wherein said phase-shift rings impose a phase shift of π radians on the portion of a wavefront that is incident on each said ring.

19. The lithography system as claimed in claim 16, wherein each phase-shifting element is a plurality of concentric rings.

20. A substrate imaged using a lithography system having a source of radiation energy; a zone plate array to focus the radiation energy to create an array of images in order to produce a permanent pattern on a substrate; and a phase-shift mask optically located between the source of radiation energy and the zone plate array.

21. A method of imaging a substrate using lithography, comprising:
(a) providing a source of radiation energy;
(b) modulating a wavefront of the radiation energy using a phase-shift mask; and
(c) focusing, using a zone plate array, the radiation energy from the phase-shift mask to create an array of images in order to produce a permanent pattern on a substrate.

22. The method as claimed in claim 21, further comprising:
(d) creating a plurality of beamlets from the source of radiation energy so that each beamlet may be turned ON and OFF, the phase-shift mask modulating the wavefront of each beamlet.

23. The method as claimed in claim 21, further comprising:
(d) creating a plurality of beamlets from the focused radiation energy so that each beamlet may be turned ON and OFF.

24. The method as claimed in claim 21, further comprising:
(d) creating a plurality of beamlets from the focused radiation energy so that each beamlet may be turned ON and OFF, the zone plate array focusing the beamlets to create an array of images in order to produce a permanent pattern on a substrate.

25. A method of imaging a substrate using lithography, comprising:
(a) providing a source of radiation energy;
(b) phase-shifting a portion of a wavefront of the radiation energy using a phase-shift mask; and
(c) focusing, using a zone plate array, the radiation energy from the phase-shift mask to create an array of images in order to produce a permanent pattern on a substrate.

26. The method as claimed in claim 25, further comprising:
(d) creating a plurality of beamlets from the source of radiation energy so that each beamlet may be turned ON and OFF, the phase-shift mask modulating the wavefront of each beamlet.

27. The method as claimed in claim 25, further comprising:
(d) creating a plurality of beamlets from the focused radiation energy so that each beamlet may be turned ON and OFF.

28. The method as claimed in claim 25, further comprising:
(d) creating a plurality of beamlets from the focused radiation energy so that each beamlet may be turned ON and OFF, the zone plate array focusing the beamlets to create an array of images in order to produce a permanent pattern on a substrate.

29. A method of imaging a substrate using lithography, comprising:
(a) providing a source of radiation energy;
(b) phase-shifting a wavefront of the radiation energy using a phase-shift mask; and
(c) focusing, using a zone plate array, the radiation energy from the phase-shift mask to create an array of images in order to produce a permanent pattern on a substrate.

30. The method as claimed in claim 29, further comprising:
(d) creating a plurality of beamlets from the source of radiation energy so that each beamlet may be turned ON and OFF, the phase-shift mask modulating the wavefront of each beamlet.

31. The method as claimed in claim 19, further comprising:
(d) creating a plurality of beamlets from the focused radiation energy so that each beamlet may be turned ON and OFF.

32. The method as claimed in claim 29, further comprising:
(d) creating a plurality of beamlets from the focused radiation energy so that each beamlet may be turned ON and OFF, the zone plate array focusing the beamlets to create an array of images in order to produce a permanent pattern on a substrate.
